(19) United States
(12) Patent Application Publication
(10) Pub. No.: US 2015/0302671 A1
(43) Pub. Date: Oct. 22, 2015

(54) METHOD AND DEVICE FOR DETERMINING A PLURALITY OF PERFORMANCE INDICATORS RELATING TO THE FLIGHT OF AN AIRCRAFT, AND ASSOCIATED COMPUTER PROGRAM PRODUCT

(71) Applicant: THALES, Neuilly Sur Seine (FR)

(72) Inventors: Jérôme Sacle, Toulouse (FR); Harvé Goutelard, Toulouse (FR); Patrick Delpy, Toulouse (FR)

(21) Appl. No.: 14/517,458

(22) Filed: Oct. 17, 2014

(30) Foreign Application Priority Data
Oct. 21, 2013 (FR) 1302433

(51) Int. Cl. G07C 5/08; G08G 5/00; B64D 43/00

(52) U.S. Cl. CPC G07C 5/0825; B64D 43/00; G08G 5/0021

(57) ABSTRACT

A method and device for determining a plurality of performance indicators relating to the flight of an aircraft and an associated computer program product are disclosed. In one aspect, the method includes calculating a first performance indicator based on an estimated time of arrival of the aircraft at the arrival location, an estimated flight time of the aircraft from its take-off until its arrival at the arrival location, and an estimated amount of fuel consumed by the aircraft up to the arrival location. The method further includes calculating at least one other performance indicator among second and third performance indicators. The second performance indicator is calculated based on a time difference between the estimated arrival time and the intended arrival time. The third performance indicator is calculated based on a consumption difference between the estimated amount of consumed fuel and the intended amount of consumed fuel and an additional quantity.

### CROSS-REFERENCE TO RELATED APPLICATIONS

This application claims benefit under 35 U.S.C. §119 of French Application No. 13 02433, filed Oct. 21, 2013, which is herein incorporated by reference in its entirety.

### BACKGROUND OF THE INVENTION

1. Field of the Invention

The described technology relates to a method for determining a plurality of performance indicators relating to the flight of an aircraft to an arrival location. The method is applied by an electronic device comprising a memory capable of storing a flight plan of the aircraft and a predetermined value of a predicted amount of fuel consumed during the flight, the flight plan including a predicted arrival time at the arrival location.

The method comprises the calculation of a first performance indicator depending on an estimated time of arrival of the aircraft at the arrival location, on an estimated flight time of the aircraft from its take-off until its arrival at the arrival location, and on an estimated amount of fuel consumed by the aircraft up to the arrival location.

The described technology also relates to a computer program product including software instructions which when they are applied by a computer, apply such a determination method.

The described technology also relates to an electronic device for determining the plurality of performance indicators relating to the flight of the aircraft.

2. Description of the Related Art

As used herein, an aircraft is any machine capable of flying within the earth's atmosphere, such as an airplane or further a remotely controlled aircraft, also called a drone.

In the field of flight management of the aircraft, a permanent challenge consists of providing the pilot of the airplane, or else the operator remotely controlling the drone, with indicators allowing optimization of the management of the flight according to a certain number of measured quantities and of pre-determined constraints.

A method of the aforementioned type is known from document U.S. Pat. No. 7,606,658 B2. This method consists of calculating a cost indicator depending on the time-dependent change of the trajectory of the airplane from a determined point of the flight plan. This calculated indicator is then displayed on a screen so as to be taken into account by the crew of the plane. The cost indicator is calculated depending on an estimation of an amount of fuel consumed by the airplane up to its final destination and also depending on economical parameters such as the cost of the crew, the operating cost per unit time.

However, the indicator determined by such a method is not optimum, and essentially takes into account economic constraints.

### SUMMARY OF CERTAIN INVENTIVE ASPECTS

An object of certain embodiments is therefore to propose a method and a device for determining a plurality of indicators with which it is possible to improve the relevance of the calculated indicators in order to optimize the management of the flight of the aircraft.

For this purpose, certain embodiment disclose a method of the aforementioned type, wherein the method further comprises the calculation of at least one other performance indicator among the second and third performance indicators,

the second performance indicator being calculated depending on a time shift between the estimated arrival time and the intended arrival time, and

the third performance indicator being calculated depending on a consumption difference between the estimated amount of consumed fuel and the intended amount of consumed fuel and on at least one additional quantity among the following: a noise level generated by the aircraft and a duration of use of an auxiliary electric motor powered by turbines of the aircraft.

According to other advantageous aspects of certain embodiments, the determination method comprises one or several of the following features, taken individually or according to all the technically possible combinations:
said method comprises the calculation of each of the performance indicators among the second and third performance indicators;
the electronic device further comprises a display screen, and the method further comprises the display on the screen of at least one piece of information relating to each of the calculated performance indicators;
the aircraft is an airplane including a cabin, and the method further comprises the calculation of a fourth performance indicator depending on the time shift and on at least one additional quantity among the following: a cumulative duration for the crossing of turbulence areas and a measured value of the pressure inside the cabin;
said method further comprises the calculation of a global indicator from different calculated performance indicators;
during the step for calculating the global indicator, each calculated performance indicator is further multiplied by a respective weighting coefficient and the global indicator then verifies the following equations:

$${Ind}_{G} = {\sum }_{i = 1}^{N} {α}_{i} \times {Ind}_{i}$$

$${\sum }_{i = 1}^{N} {α}_{i} = 1$$

wherein i is an index of the calculated performance indicator,

N represents the number of calculated performance indicators,

Ind_{G} represents the global indicator,

Indᵢ represents the calculated performance indicator of index i, and

αᵢ represents the weighting coefficient of the calculated performance indicator of index i.
said method further comprises the generation of an alert when at least one performance indicator among the different calculated performance indicators is outside a predetermined range of values; and
the electronic device further comprises a display screen, and the method comprises the determination of at least one corrective action for improving at least one calculated performance indicator, and the display on the screen of each determined corrective action.

Another object of certain embodiments is a computer program product including software instructions which, when they are applied by a computer, apply a method as defined above.

Another object of certain embodiments is an electronic device for determining a plurality of performance indicators relating to the flight of an aircraft to an arrival location,

the aircraft comprising a memory capable of storing a flight plan of the aircraft and a predetermined value of an intended amount of fuel consumed during the flight, the flight plan including an intended arrival time at the arrival location,

the aircraft comprising first estimation means for estimating an arrival time of the aircraft at the arrival location, second estimation means for estimating a flight time of the aircraft from its take-off until its arrival at the arrival location, and third estimation means for estimating an amount of consumed fuel by the aircraft up to the arrival location,

the device comprising:
first calculation means for calculating a first performance indicator depending on the estimated arrival time, on the estimated flight time, and on the estimated amount of consumed fuel,

wherein it further comprises calculation means for calculating at least one other performance indicator among the second and third performance indicators,

the second performance indicator being calculated depending on a time shift between the estimated arrival time and the intended arrival time, and

the third performance indicator being calculated depending on the difference in consumption and on at least one additional quantity among the group consisting in: a noise level generated by the aircraft and a duration for using an auxiliary electric motor powered by turbines of the aircraft.

### BRIEF DESCRIPTION OF THE DRAWINGS

These features and advantages of the described technology will become apparent upon reading the description which follows, only given as a non-limiting example and made with reference to the appended drawings, wherein:

FIG. 1 is a schematic illustration of an aircraft comprising a flight management system and a device for determining a plurality of performance indicators according to an embodiment,

FIG. 2 is a schematic illustration of the determination device and of the flight management system of FIG. 1,

FIG. 3 is a flow chart of a method for determining the plurality of performance indicators according to an embodiment,

FIGS. 4 to 6 illustrate function curves allowing calculation of the elementary indicators used for determining the performance indicators,

FIG. 7 is a schematic illustration of the display on a screen of the calculated performance indicators and of a global indicator, and

FIG. 8 is a schematic illustration of the display on the screen of detailed pieces of information relating to a given performance indicator.

### DETAILED DESCRIPTION OF CERTAIN ILLUSTRATIVE EMBODIMENTS

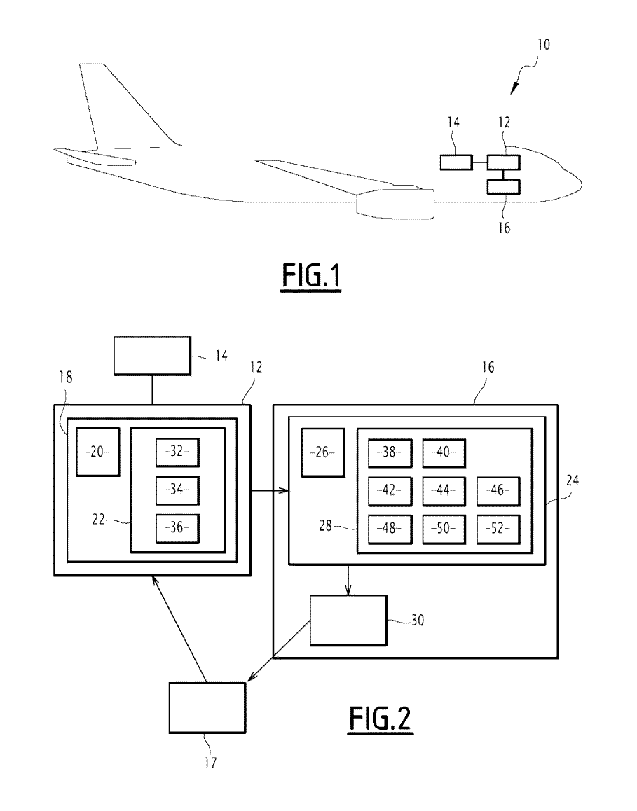

In FIG. 1, an aircraft 10 is in a flight phase within the earth's atmosphere and to an arrival location, not shown. The aircraft 10 comprises a management system 12 of the flight of the aircraft, also called FMS (Flight Management System), an automatic pilot device 14, an electronic device 16 for determining a plurality N of performance indicators Indᵢ relating to the flight of the aircraft 10.

In the exemplary embodiment of FIG. 1, the aircraft 10 is an airplane and includes a cabin, not shown, inside which the pressure is generally different from the pressure outside the aircraft 10. A crew 17, visible in FIG. 2, and passengers, not shown, are installed inside the cabin.

In the following description, i is an indicator of the corresponding calculated performance indicator Indᵢ, and N represents the number of calculated performance indicators Indᵢ.

The flight management system 12 is connected, bound to a plurality of measurement units, not shown and known per se, such as an inertial reference including accelerometers and gyroscopes, a radio-altimeter, a geo-localization system. The flight management system is able to determine the trajectory of the aircraft 10 and to estimate various quantities, such as the altitude, the speed, from measurements carried out with the measurement units.

The flight management system 12 includes a first processing unit 18, for example formed with a first processor 20 and a first memory 22 associated with the first processor 20.

The automatic pilot device 14 is known per se and is not described in more detail.

The determination device 16 includes a second processing unit 24 for example formed with a second processor 26 and a second memory 28 associated with the second processor 26. Additionally, the determination device 16 further includes a display screen 30, notably intended to display pieces of information relating to the calculated performance indicators Indᵢ.

The first memory 22 is able to store a flight plan of the aircraft 10 and a predetermined value of an intended amount of consumed fuel during the flight, the flight plan including an intended arrival time in the arrival location.

The first memory 22 is able to store a first software 32 for estimating an arrival time of the aircraft in the arrival location, a second software 34 for estimating a flight time of the aircraft from its take off until its arrival at the arrival location, and a third software 36 for estimating an amount of consumed fuel by the aircraft until the arrival location.

Alternatively, the first estimation means 32, the second estimation means 34 and the third estimation means 36 are made in the form of programmable logic components (FPGA) or further in the form of dedicated integrated circuits (ASIC).

The second memory 28 is able to store a first software 38 for calculating a first performance indicator Ind₁ of the aircraft 10 depending on the estimated arrival time, on the estimated flight time, and on the estimated amount of fuel consumed.

According to the certain embodiments, the second memory 28 is further able to store at least one other software among a second software 40 for calculating a second performance indicator Ind₂ of the aircraft and a third software 42 for calculating a third performance indicator Ind₃ of the aircraft.

The second performance indicator Ind₂ is calculated depending on a time difference between the estimated arrival time and the intended arrival time.

The third performance indicator Ind₃ is calculated depending on the difference in consumption and on an additional quantity among the following: a noise level generated by the aircraft and the duration of use of an auxiliary electric motor, not shown, powered by turbines, not shown, of the aircraft.

Additionally, the second memory 28 is able to store a fourth software 44 for calculating a fourth performance indicator Ind₄ of the aircraft.

The fourth performance indicator Ind₄ is calculated depending on the time difference and on at least one additional quantity among the following: a cumulated duration for crossing turbulence areas and a measured value of the pressure inside the cabin.

The second memory 28 is able to store a fifth software 46 for calculating a global indicator Ind_{G} from the different calculated performance indicators Indᵢ.

For calculating the global indicator Ind_{G}, each performance indicator Indᵢ is, for example, multiplied by a respective weighting coefficient αᵢ. The sum of the weighting coefficients αᵢ is equal to 1. The global indicator Ind_{G} then verifies the following equations:

$$\begin{matrix}{Ind}_{G} = {\sum }_{i = 1}^{N} {α}_{i} \times {Ind}_{i} & ( 1 ) \\ {\sum }_{i = 1}^{N} {α}_{i} = 1 & ( 2 )\end{matrix}$$

wherein Indᵢ represents the calculated performance indicator of index i, and

αᵢ represents the weighting coefficient of the calculated performance indicator of index i.

The second memory 28 is able to store a software 48 for displaying on the screen 30 at least one piece of information relating to the calculated performance indicators Indᵢ, Ind_{G}.

The second memory 28 is able to store a software 50 for determining at least one corrective action for improving at least one calculated performance indicator Indᵢ, Ind_{G}, each determined corrective action being able to be displayed on the screen 30 by the display software 48.

Additionally, the second memory 28 is able to store a software 52 for generating an alert when at least one performance indicator Indᵢ, Ind_{G} among the different calculated performance indicators is outside a predetermined range of values.

Alternatively, the first calculation means 38, the second calculation means 48, the third calculation means 42, the fourth calculation means 44, the fifth calculation means 46, the display means 48, the determination means 50 and the generation means 52 are made in the form of programmable logic components, or further in the form of dedicated integrated circuits.

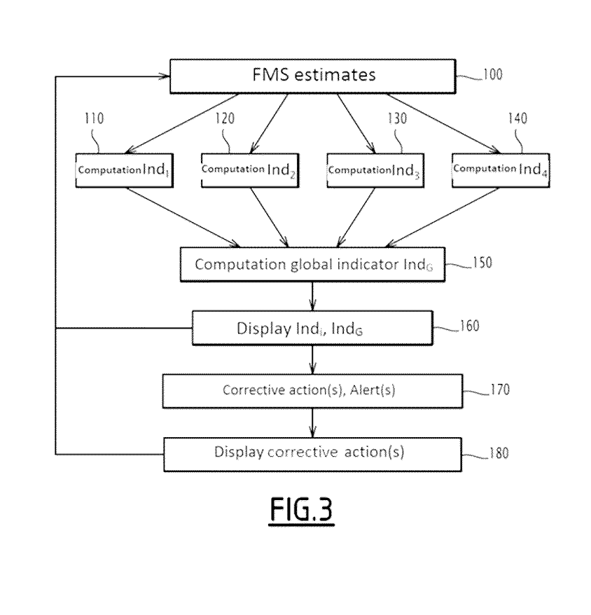

The operation of the determination device 16 will now be explained by means of FIG. 3 illustrating a flow chart of the determination method according to certain embodiments.

During an initial step 100, the flight management system 12 carries out estimations, in a way known per se, of quantities relating to the flight of the aircraft 10, such as an arrival time of the aircraft 10 at the arrival location, also noted as ETA (Estimated Time of Arrival), a flight time of the aircraft 10 from its take off until its arrival at the arrival location, and an amount of fuel consumed by the aircraft 10 up to its arrival location.

When the aircraft 10 is an airplane, the flight management system 12 also estimates an arrival time of the plane 10 to the parking space, also noted as GETA (Gate Estimated Time of Arrival). The arrival time GETA is for example equal to the sum of the arrival time ETA, corresponding to the time when the airplane 10 has landed, and of the duration for rolling between the location of the landed aircraft and the parking space.

This step for estimating the quantities relating to the flight of the aircraft is periodically carried out by the flight management system 12, notably by means of first, second and third estimation software packages 32, 34, 36.

The determination device 16 then calculates, respectively during steps 110, 120, 130, 140, respectively by means of its first calculation software 38, of its second calculation software 40, and of its third calculation software 42 and of its fourth calculation software 44, the first performance indicator Ind₁, the second performance indicator Ind₂, the third performance indicator Ind₃ and respectively the fourth performance indicator Ind₄.

The steps 110, 120, 130, 140 are carried out in parallel by the determination device 16 from estimations of the different quantities carried out during step 100, without the instants for beginning each of these steps 110, 120, 130, 140 however being necessarily synchronized.

Each performance indicator Ind₁, Ind₂, Ind₃, Ind₄ is for example calculated depending on elementary indicators Ind_{i—}elⱼ, wherein j is an indicator of the elementary indicator and i is an index of the corresponding performance indicator.

Each elementary indicator Ind_{i—}elⱼ is, for example, calculated according to a single quantity among the different quantities taken into account for calculating the corresponding performance indicator Ind₁, Ind₂, Ind₃, Ind₄. Each performance indicator Ind₁, Ind₂, Ind₃, Ind₄ is, for example, equal to a weighted sum of these elementary indicators Ind_{i—}elⱼ.

Each elementary indicator Ind_{i—}elⱼ, is, for example, expressed as a percentage. The corresponding elementary indicator Ind_{i—}elⱼ is for example equal to 100% when the estimated value of the considered quantity is equal to the intended value of this quantity, the indicator being greater than 100% when the estimated value is better than the intended value and less than 100% when the estimated value is not as good as the intended value. Each performance indicator Ind₁, Ind₂, Ind₃, Ind₄ is also, for example, expressed as a percentage.

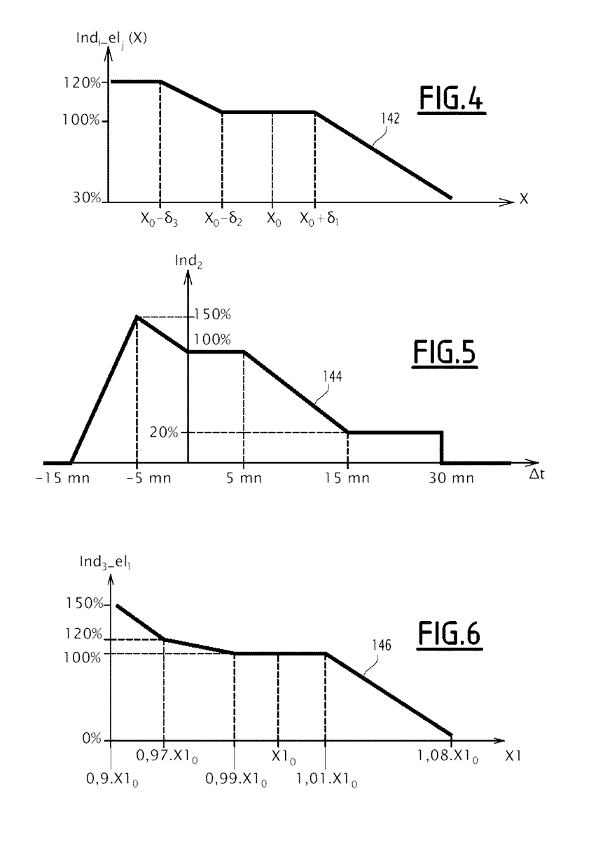

The value of the elementary indicator Ind_{i—}elⱼ is, for example, expressed by a piecewise affine function of the estimated value of the considered quantity, as illustrated in FIG. 4. In FIG. 4, the value of the elementary indicator Ind_{i—}elⱼ depending on the quantity X taken into account is illustrated by the curve 142 which is in the form of a succession of segments. In other words, for a given interval of values of the estimated quantity X relative to the intended value X₀, the value of the elementary indicator Ind_{i—}elⱼ is an affine function of the estimated quantity X.

In the exemplary embodiment of FIG. 4, the elementary indicator Ind_{i—}elⱼ is equal to 100% when the value of the estimated quantity X is in the range [X₀−δ₂; X₀+δ₁] around the intended value X₀, the value of the elementary indicator Ind_{i—}elⱼ decreases linearly from 100% to 30% when the value of the estimated quantity X is greater than X₀+δ₁, the value of the elementary indicator Indᵢ elⱼ increases linearly from 100% up to 120% when the value of the estimated quantity X varies from X₀−δ₂ up to X₀−δ₃, and the value of the elementary indicator Ind_{i—}elⱼ is equal to 120% when the value of the estimated quantity X is less than X₀−δ₃, wherein δ₁, δ₂ and δ₃ are the differences of values expressed in the same unit as a quantity with δ₂<δ₃.

During step 110, the determination device 16 calculates, by means of its first calculation software 38, the first performance indicator Ind₁ depending on the estimated arrival time ETA, GETA, on the estimated flight time and on the estimated amount of consumed fuel.

The first performance indicator Ind₁ is also called a cost indicator, the estimated amount of consumed fuel allowing calculation of a fuel cost and of a carbon tax cost, the estimated flight time allowing a calculation of the maintenance cost and a cost of the crew 17, and the estimated arrival time allowing calculation of the sum of a landing tax, and optionally the sum of a noise fine and of a bonus for the crew 17.

During step 120, the determination device 16 calculates, by means of its second calculation software 40, the second performance indicator Ind₂ depending on the time difference between the estimated arrival time and the intended arrival time.

The value of the second performance indicator Ind₂ is, for example, a piecewise affine function of the time difference, as illustrated in FIG. 5 wherein the time difference is noted as Δt and the curve 144 which represents this value of the second performance indicator Ind₂ is in the form of a succession of segments. In the exemplary embodiment of FIG. 5, the second performance indicator Ind₂ has a low value, comprised between 0% and 20%, while the time difference Δt relative to the intended arrival time ETA, GETA is in absolute value greater than 15 minutes.

The second performance indicator Ind₂ is also called a time indicator, given that it directly expresses the impact of a time delta relative to the intended arrival time.

During step 130, the determination device 16 calculates, by means of its third calculation software 42, the third performance indicator Ind₃ depending on the consumption difference and on at least one additional quantity among the following: a noise level generated by the aircraft and a duration of use of the auxiliary electric motor powered by the turbines of the aircraft.

The third performance indicator Ind₃ is, for example, calculated depending on three elementary distinct indicators Ind_{3—}el₁, Ind_{3—}el₂ and Ind_{3—}el₃.

In the exemplary embodiment described, the first elementary indicator Ind_{3—}el₁ associated with the third performance indicator is only calculated depending on the consumption difference, the second elementary indicator Ind_{3—}el₂ associated with the third performance indicator is only calculated depending on the noise level generated by the aircraft 10, and the third elementary indicator Ind_{3—}el₃ associated with the third performance indicator is only calculated depending on the duration of use of the auxiliary electric motor of the aircraft 10.

For calculating the third performance indicator Ind₃, each elementary indicator Ind_{3—}elⱼ is, for example, multiplied by a respective weighting coefficient βⱼ. The sum of the weighting coefficients βⱼ is equal to 1. The third performance indicator Ind₃ then verifies the following equations:

$$\begin{matrix}{Ind}_{3} = {\sum }_{j = 1}^{J} {β}_{j} \times {Ind}_{3 {\_ el}_{j}} & ( 3 ) \\ {\sum }_{j = 1}^{J} {β}_{j} = 1 & ( 4 )\end{matrix}$$

wherein Ind_{3—}elⱼ represents the elementary indicator of index j for the third performance indicator Ind₃, and

βⱼ represents the weighting coefficient of the elementary indicator of index j.

The first elementary indicator value Ind_{3—}el₁ associated with the third performance indicator is, for example, a piecewise affine function of the amount of estimated consumed fuel, as illustrated in FIG. 6 where the estimated amount of consumed fuel is noted as X1 and the curve 146 which represents this value of the first elementary indicator Ind_{3—}el₁ is in the form of a succession of segments.

In the exemplary embodiment of FIG. 6, the first elementary indicator Ind_{3—}el₁ has a value equal to 100% for a consumption difference of less than 1%, relative to the intended amount of consumed fuel, noted as X1₀. The first elementary indicator Ind_{3—}el₁ has a value which strongly decreases as soon as the estimated amount of consumed fuel exceeds by more than 1% the intended amount of consumed fuel, the value of the first elementary indicator being zero as soon as the estimated amount of consumed fuel is greater than 108% of the intended amount of consumed fuel. Conversely, the first elementary indicator Ind_{3—}el₁ has a value which strongly increases as soon as the estimated amount of consumed fuel is less than 99% of the intended amount of consumed fuel, the value of this first elementary indicator Ind_{3—}el₁ being greater than 120% when the estimated amount of consumed fuel is less than 97% of the intended amount of consumed fuel. These percentage values are given as an example and other values may of course be considered.

The third performance indicator Ind₃ is also called an environmental indicator, given that it expresses the impact on the environment of the consumption difference and also of an additional quantity among the noise level generated by the aircraft 10 and the duration of use of the auxiliary electric motor.

During step 140, the determination device 16 calculates in the case when the aircraft 10 is an airplane and by means of its fourth calculation software 44, the fourth performance indicator Ind₄ depending on the time difference and on at least one additional quantity from the following: a cumulated duration for crossing turbulence areas and a measured value of the pressure inside the cabin.

The fourth performance indicator Ind₄ is also called a customer satisfaction indicator, given that it reflects the impact on the passenger of the plane 10 of the time difference relative to the intended arrival time, is also an additional quantity among the cumulated duration for crossing turbulence areas and the measured value of the pressure inside the cabin, which each partly characterize a sensation of the quality of the flight by the passenger.

At the end of the steps 110, 120, 130, 140, the determination device 16 calculates, by means of its fifth calculation software 46 and according to the preceding equations (1) and (2), the global index Ind_{G} from the different performance indicators Indᵢ calculated from the four performance indicators Ind₁, Ind₂, Ind₃, Ind₄ described earlier.

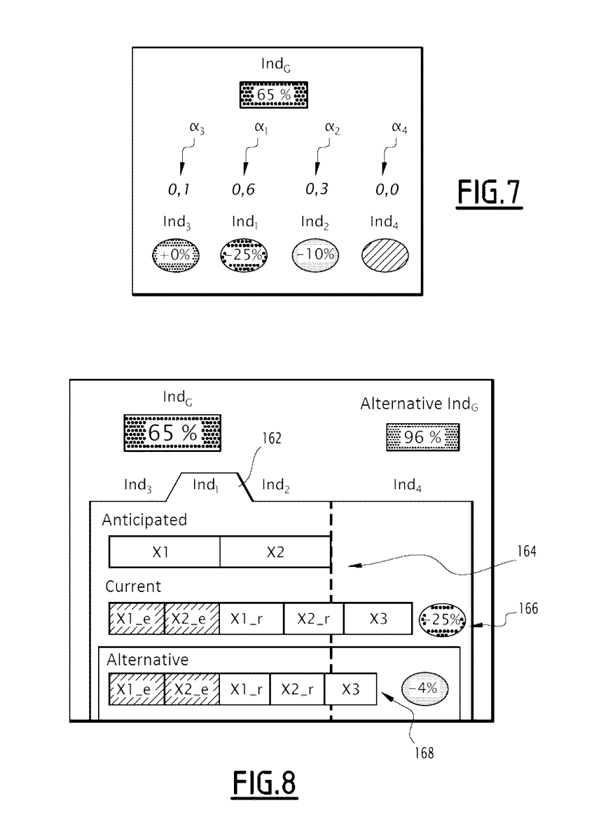

The determination device 16 then displays, during step 160 and by means of its display software 48, on the screen 30 pieces of information relating to the calculated performance indicators Indᵢ, as illustrated in FIG. 7. In FIG. 7, the different indicators Ind₁, Ind₂, Ind₃, Ind₄ are illustrated by an indicator in the form of a disc, the indicator being gray or hatched when the corresponding indicator Indᵢ has not been calculated, as is the case with the fourth performance indicator Ind₄ in the illustrated example. The indicator illustrating the calculated performance indicator Indᵢ is of a green color when the value of the corresponding indicator Indᵢ is greater than or equal to 100%, of an orange color when the value of this indicator Indᵢ is comprised between 80% and 100% and of red color when the value of this indicator Indᵢ is less than 80%. Additionally, the indicator also contains inside the disc, a value illustrating the difference of the value of the calculated indicator Indᵢ relative to a reference value equal to 100%. Additionally, the values of the weighting coefficients α₁, α₂, α₃, α₄ associated with the performance indicators Ind₁, Ind₂, Ind₃, Ind₄ are also displayed in the form of a numerical value comprised between 0 and 1. The value of the weighting coefficient is of course zero when the corresponding indicator has not been calculated, such as the fourth performance indicator Ind₄ in the illustrated example. These colors are given as an example, and other colors may of course be considered.

In FIG. 7, the global indicator Ind_{G} resulting from the calculated performance indicators is also displayed by means of a rectangular shaped indicator, the color of which depends on the value of the global indicator, the color for example being green when the value of the global indicator Ind_{G} is greater than or equal to 100%, orange when the value of this indicator Ind_{G} is comprised between 80% and 100% and red when the value of this indicator Ind_{G} is less than 80%. Additionally, the indicator contains, inside the rectangle, the value of the global indicator Ind_{G} in the form of an integer number of percent.

During the next step 170, the determination device 16 then determines, by means of its determination software 50, one or several corrective actions aiming at improving one or several calculated performance indicators Indᵢ, and more generally aiming at improvement of the global indicator Ind_{G}.

In order to determine the corrective action(s), the determination device 16 begins by calculating the time derivatives of order 1 and 2 of the global indicator Ind_{G} in order to determine whether the variation of the global indicator Ind_{G} is a continuous variation or else if there was a rupture in the variation of this value. In the case of continuous variation of the value of the global indicator Ind_{G}, the quantity having the most influence on this variation is detected notably by means of the equations (1) to (4), the determination software 50 then determines one or several corrective actions aiming at limiting the influence of the detected quantity. In the case of rupture in the variation of the value of the global indicator Ind_{G}, the performance indicator corresponding to this rupture is detected by means of the equations (1) and (2), and then corrective deviations are successively applied to the quantities associated with the detected performance indicator so as to determine the corrective action(s), for example, with limitation to the three best. The proposed corrective actions are those corresponding to the corrective deviations improving the most significantly the value of the detected performance indicator.

Additionally, during step 170, an alert is generated by the determination device 16 by means of its generation software 52 when at least one performance indicator among the different calculated performance indicators Indᵢ is outside a predetermined range of values, and for example when the global indicator Ind_{G} is smaller than a predetermined threshold value.

Finally, during step 180, the determined corrective action(s) are displayed on the screen 30 by the determination device 16 by means of its display software 48, as illustrated in FIG. 8.

FIG. 8 illustrates the display of more detailed information relating to a selected performance indicator among the different performance indicators Ind₁, Ind₂, Ind₃, Ind₄. These pieces of information are accessible by choosing a tab 162 corresponding to the desired performance indicator, such as for example the first performance indicator Ind₁ in the example of FIG. 8.

The presented detailed pieces of information for example comprise a first line 164 of information relating to the intended values of the different quantities taken into account for calculating the corresponding performance indicator Indᵢ, a second line 166 of information relating to the present values of the different quantities and a third line 168 of information relating to alternative values of these different quantities according to a determined corrective action by means of the determination software 50. In the example of FIG. 8, three quantities, i.e. the estimated amount of consumed fuel X1, and two other quantities X2, X3, are taken into account for calculating the first performance indicator Ind₂. For displaying the second and third lines 166, 168, hatched areas correspond to already elapsed values of the respective quantities X1, X2, and the non-hatched areas correspond to the estimated remaining values of these quantities, the elapsed values being noted as X1_{—}e, X2_{—}e and the estimated remaining values being noted as X1_{—}r, X2_{—}r.

It is thus conceivable that the determination method and device 16 according to certain embodiments allows improvement in the relevance of the calculated indicators Indᵢ in order to optimize flight management of the aircraft 10.

One skilled in the art will understand that the weighting used for calculating the global indicator Ind_{G} and each weighting used for calculating a respective performance indicator Indᵢ are each a weighting with a weighted sum, or a variable weighting, or further a weighting depending on several variables.

In other words, in the case of the weighted sum, each weighting coefficient αᵢ, βⱼ is constant and the sum of the weighting coefficients αᵢ, βⱼ is equal to 1, in accordance with the equations (2) and (4) notably.

In the case of variable weighting, each weighting coefficient αᵢ, βⱼ is of variable value, while having a sum of weighting coefficients always equal to 1.

In the case of weighting depending on several variables x, y, z, each weighting coefficient is of a variable value and depends on one or several of these variables x, y, z.

The value of each weighting coefficient is positive, zero or negative. When the value of a weighting coefficient is negative, the indicator associated with said weighting coefficient is then removed from the other indicators.

By dependency on one or several variables x, y, z, is notably meant dependency depending on the result of an equation or of an inequation involving said variable(s) x, y, z.

As a purely illustrative example, the weighting coefficient α₁ of the calculated performance indicator of index 1 depends on the variables x and y, the weighting coefficient α₂ of the performance indicator of index 2 depends on the variable x, the weighting coefficient α₃ of the performance indicator of index 3 depends on the variable y and the weighting coefficient α₄ of the calculated performance indicator of index 4 depends on the variables x and z. The coefficient α₁ for example assumes a first value when the variable x is less than the variable y, and a second value when the variable x is greater than or equal to the variable y. The coefficient α₄ for example is negative when the variable x is equal to twice of the variable z.

The variables x, y, z for example are performance indicators or elementary indicators being subject to the weighting. Alternatively, the variables x, y, z are distinct from the indicators subject to weighting.

In the case of weighting depending on several variables x, y, z, the function allowing calculation of the global indicator Ind_{G} and/or each respective performance indicator Indᵢ is also generally a so-called multi-criteria function.

The computing environment included in the flight management system 12 and/or the determination device 16 includes computer programs or code. Computer programs are executed by data processors. Each program may contain a number of modules and whether modularized or not, instructions to be read and executed by a computing environment. Instructions refer to computer-implemented steps for processing information in the system. Instructions can be implemented in software, firmware or hardware and include any type of programmed step undertaken by components of the system.

The computing environment also includes one or more memories such as the first memory 22 and the second memory 28. Memory refers to electronic circuitry that allows information, typically computer data, to be stored and retrieved. Memory can refer to external devices or systems, for example, disk drives or tape drives. Memory can also refer to fast semiconductor storage (chips), for example, random access memory (RAM) or various forms of read only memory (ROM) are directly connected to the processor. Other types of memory include flash, RRAM, STTRAM, DRAM, SRAM, hard disk drives, etc. Such computer readable memories are generally non-transitory.

As can be appreciated by one of ordinary skill in the art, each of the modules or software of the program(s) can include various sub-routines, procedures, definitional statements, and macros. Each of the modules are typically separately compiled and linked into a single executable program. Therefore, any description of modules or software is used for convenience to describe the functionality of the system. Thus, the processes that are undergone by each of the modules may be arbitrarily redistributed to one of the other modules, combined together in a single module, or made available in a shareable dynamic link library. Further each of the modules could be implemented in hardware.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

While there have been shown and described and pointed out the fundamental novel features of the invention as applied to certain inventive embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplate. All such modifications and variations are within the scope of the invention as determined by the appended claims when interpreted in accordance with the breadth to which they are entitled.

What is claimed is:

1. A method for determining a plurality of performance indicators relating to the flight of an aircraft to an arrival location, the method being applied by an electronic device, the aircraft comprising a memory configured to store a flight plan of the aircraft and a predetermined value of an intended amount of consumed fuel during the flight, the flight plan including an intended arrival time at the arrival location, the method comprising:
calculating a first performance indicator based on: i) an estimated time of arrival of the aircraft at the arrival location, ii) an estimated flight time of the aircraft from its take-off until its arrival at the arrival location, and iii) an estimated amount of fuel consumed by the aircraft up to the arrival location; and
calculating at least one other performance indicator among second and third performance indicators,
wherein the second performance indicator is calculated based on a time difference between the estimated arrival time and the intended arrival time, and
wherein the third performance indicator is calculated based on: i) a consumption difference between the estimated amount of consumed fuel and the intended amount of consumed fuel and ii) at least one additional quantity among the following: a noise level generated by the aircraft and a duration of use of an auxiliary electric motor powered by turbines of the aircraft.

2. The method according to claim 1, further comprising calculating both of the second and third performance indicators.

3. The method according to claim 1, wherein the electronic device further comprises a display screen and wherein the method further comprises displaying on the display screen at least one piece of information relating to each of the calculated performance indicators.

4. The method according to claim 1, wherein the aircraft is an airplane including a cabin and wherein the method further comprises calculating a fourth performance indicator based on: i) the time difference and ii) at least one additional quantity among the following: a cumulated duration for crossing turbulence areas and a measured value of the pressure inside the cabin.

5. The method according to claim 1, wherein the method further comprises calculating a global indicator from the different calculated performance indicators.

6. The method according to claim 5, wherein calculating the global indicator comprises multiplying each calculated performance indicator by a respective weighting coefficient, the global indicator satisfying the following equations:
$$\begin{matrix}{Ind}_{G} = {\sum }_{i = 1}^{N} {α}_{i} \times {Ind}_{i} \\ {\sum }_{i = 1}^{N} {α}_{i} = 1\end{matrix}$$
wherein i is an index of a calculated performance indicator,
N represents the number of calculated performance indicators,
Ind_{G} represents the global indicator,
Indᵢ represents the calculated performance indicator of index i, and
αᵢ represents the weighting coefficient of the calculated performance indicator of index i.

7. The method according to claim 1, wherein the method further comprises generating an alert when at least one performance indicator among the different calculated performance indicators is outside a predetermined range of values.

8. The method according to claim 1, wherein the electronic device further comprises a display screen and wherein the method further comprises:
determining at least one corrective action for improving at least one calculated performance indicator; and
displaying on the display screen each determined corrective action.

9. A computer program product including software instructions which when executed by a computer, cause the computer to perform a method comprising:
calculating a first performance indicator based on: i) an estimated time of arrival of an aircraft at an arrival location, ii) an estimated flight time of the aircraft from its take-off until its arrival at the arrival location, and iii) an estimated amount of fuel consumed by the aircraft up to the arrival location; and
calculating at least one other performance indicator among second and third performance indicators,
wherein the second performance indicator is calculated based on a time difference between the estimated arrival time and an intended arrival time, and
wherein the third performance indicator is calculated based on: i) a consumption difference between the estimated amount of consumed fuel and an intended amount of consumed fuel and ii) at least one additional quantity among the following: a noise level generated by the aircraft and a duration of use of an auxiliary electric motor powered by turbines of the aircraft.

10. An electronic device for determining a plurality of performance indicators relating to the flight of an aircraft to an arrival location,
the aircraft comprising a memory configured to store a flight plan of the aircraft and a predetermined value of an intended amount of fuel consumed during the flight, the flight plan including an intended arrival time at the arrival location,
the aircraft further comprising: i) a first estimation module configured to estimate an arrival time of the aircraft at the arrival location, ii) a second estimation module configured to estimate a flight time of the aircraft from its take-off to its arrival at the arrival location, and iii) a third estimation module configured to estimate an amount of fuel consumed by the aircraft right up to the arrival location,
the device comprising:
a first calculation module configured to calculate a first performance indicator based on: i) the estimated arrival time, ii) the estimated flight time and iii) the estimated consumed fuel amount; and a second calculation module configured to calculate at least one other performance indicator among second and third performance indicators,
wherein the second performance indicator is calculated based on a time difference between the estimated arrival time and the intended arrival time, and
wherein the third performance indicator is calculated based on: i) the consumption difference and ii) at least one additional quantity among the following: a noise level generated by the aircraft and a duration of use of an auxiliary electric motor powered by turbines of the aircraft.

11. The electronic device of claim 10, wherein at least one of the performance indicators is calculated based on a plurality of elementary indicators and a plurality of weighting coefficients respectively corresponding to the elementary indicators.

12. The electronic device of claim 11, wherein each elementary indicator is defined as a piecewise affine function of an estimated value of a considered flight variable.
